(19) United States
(12) Patent Application Publication
(10) Pub. No.: US 2013/0038516 A1
(43) Pub. Date: Feb. 14, 2013

(54) DISPLAY APPARATUS AND GAMMA VOLTAGE GENERATOR THEREOF

(71) Applicants: Yu Tsai, Chiayi County (TW); Che-Yu Chuang, Changhua County (TW)

(72) Inventors: Yu Tsai, Chiayi County (TW); Che-Yu Chuang, Changhua County (TW)

(73) Assignee: HANNSTAR DISPLAY CORPORATION, New Taipei City (TW)

(21) Appl. No.: 13/280,354

(22) Filed: Oct. 25, 2011

(30) Foreign Application Priority Data
Aug. 11, 2011 (TW) 100128737

(51) Int. Cl. G09G 3/36

(52) U.S. Cl. 345/89

(57) ABSTRACT

The invention provides a display apparatus and a gamma voltage generator. The gamma voltage generator includes a string of resistors and a voltage-regulating unit. The string of resistors is coupled between a first reference voltage and a second reference voltage for generating a plurality of gamma voltages. The voltage-regulating unit is used for sensing a voltage coupling amount of a common voltage in a display panel and shifting the first reference voltage and the second reference voltage according to the voltage coupling amount. In this way, the invention can eliminate the influence of coupling the display apparatus to the pixel voltages on the common voltage.

### CROSS-REFERENCE TO RELATED APPLICATION

This application claims the priority benefit of Taiwan application serial no. 100128737, filed on Aug. 11, 2011. The entirety of the above-mentioned patent application is hereby incorporated by reference herein and made a part of this specification.

### BACKGROUND OF THE INVENTION

1. Field of the Invention

The invention generally relates to a gamma voltage generator and a display apparatus, and more particularly, to a gamma voltage generator able to regulate the gamma voltage level and a display apparatus using the same.

2. Description of Related Art

Along with the progress of photoelectric technology and semiconductor technology, the flat panel display (FPD) has been in flourishing today. Among many FPDs, the liquid crystal display (LCD) has played a major role in the mainstream display market due to advantages of high space utilization, low power consumption, no radiation and low electromagnetic interference.

It is well known that in terms of the current LCD architecture, a gamma voltage generator must be employed and disposed outside the source driver of the LCD for generating a plurality of gamma voltages, and the source driver uses the gamma voltages to generate a plurality of pixel voltages and outputs the pixel voltages to a display panel. Each of the pixel voltages herein is respectively one of the gamma voltages, while the liquid crystals in the display panel would rotate according to voltage differences between the corresponding pixel voltages and a common voltage. However, when the display panel is coupled to the pixel voltages, the voltage level of the common voltage would be changed. With the inconstant common voltage, the voltage difference between a pixel voltage corresponding to a same gray level value and the common voltage is varied, which further affects the display effect of the LCD.

In order to reduce the influence of coupling a display panel to pixel voltages, some manufactures take a measure of advancing the output capacity of the buffer outputting the common voltage, but the above-mentioned measure of advancing the output capacity of the buffer would increase the required chip area used by the buffer, i.e., increase the fabrication cost of the buffer. In addition, the measure of advancing the output capacity of the buffer is unable to eliminate the influence of coupling the display panel to the pixel voltages so that the improvement is limited.

### SUMMARY OF THE INVENTION

Accordingly, the invention is directed to a gamma voltage generator for shifting a first reference voltage and a second reference voltage according to the voltage coupling amount of the display panel, so that the voltage differences between gamma voltages and the common voltage keep unchanged, in which a plurality of gamma voltages are generated referring to the first reference voltage and the second reference voltage.

The invention is also directed to a display apparatus able to shift the voltage levels of the gamma voltages according to the voltage coupling amount of the display panel so as to eliminate the influence of coupling the display panel to the pixel voltages on the common voltage.

The invention provides a gamma voltage generator, which includes a string of resistors and a voltage-regulating unit. The string of resistors is coupled between a first reference voltage and a second reference voltage for generating a plurality of gamma voltages. The voltage-regulating unit is used for sensing a voltage coupling amount of a common voltage in a display panel and shifting the first reference voltage and the second reference voltage according to the voltage coupling amount.

The invention also provides a display apparatus, which includes a display panel, an above-mentioned gamma voltage generator, a source driver and a timing controller. The gamma voltage generator is coupled to the display panel for outputting a plurality of gamma voltages and shifting the gamma voltages according to a voltage coupling amount of a common voltage in the display panel. The source driver is coupled to the gamma voltage generator to receive the gamma voltages and coupled to the display panel. The timing controller is coupled to the source driver for controlling the source driver to output a plurality of pixel voltages to the display panel, in which each of the pixel voltages is corresponding to one of the gamma voltages.

In an embodiment of the present invention, the shifting amounts of the first reference voltage and the second reference voltage are equal to the voltage coupling amount.

In an embodiment of the present invention, the first reference voltage is greater than the second reference voltage.

In an embodiment of the present invention, the gamma voltage generator further includes a capacitor coupled between the first reference voltage and the second reference voltage.

In an embodiment of the present invention, the common voltage is a DC common voltage.

In an embodiment of the present invention, the display panel is a liquid crystal display (LCD) panel.

In an embodiment of the present invention, the display apparatus further includes a gate driver coupled to the display panel and the timing controller and controlled by the timing controller to sequentially output a plurality of scan signals to the display panel.

In an embodiment of the present invention, the display apparatus further includes a backlight module for providing a planar light source required by the display panel.

Based on the description above, in the embodiment of the invention, the gamma voltage generator and the display apparatus would detect the voltage coupling amount of the display panel so as to shift the first reference voltage and the second reference voltage according to the voltage coupling amount, which makes the gamma voltages shift correspondingly to the voltage coupling amount. In this way, the invention is able to eliminate the influence of coupling the display panel to the pixel voltages on the common voltage.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic system diagram of a display apparatus according to an embodiment of the invention.

FIG. 2 is a schematic circuit diagram of the gamma voltage generator of FIG. 1 according to an embodiment of the invention.

FIG. 3 is a schematic system diagram of the voltage-regulating unit of FIG. 2 according to an embodiment of the invention.

FIG. 4 is a schematic diagram of the gamma voltages VD₁-VDₙ and the common voltage Vcom′ in FIG. 1 according to an embodiment of the invention.

### DESCRIPTION OF THE EMBODIMENTS

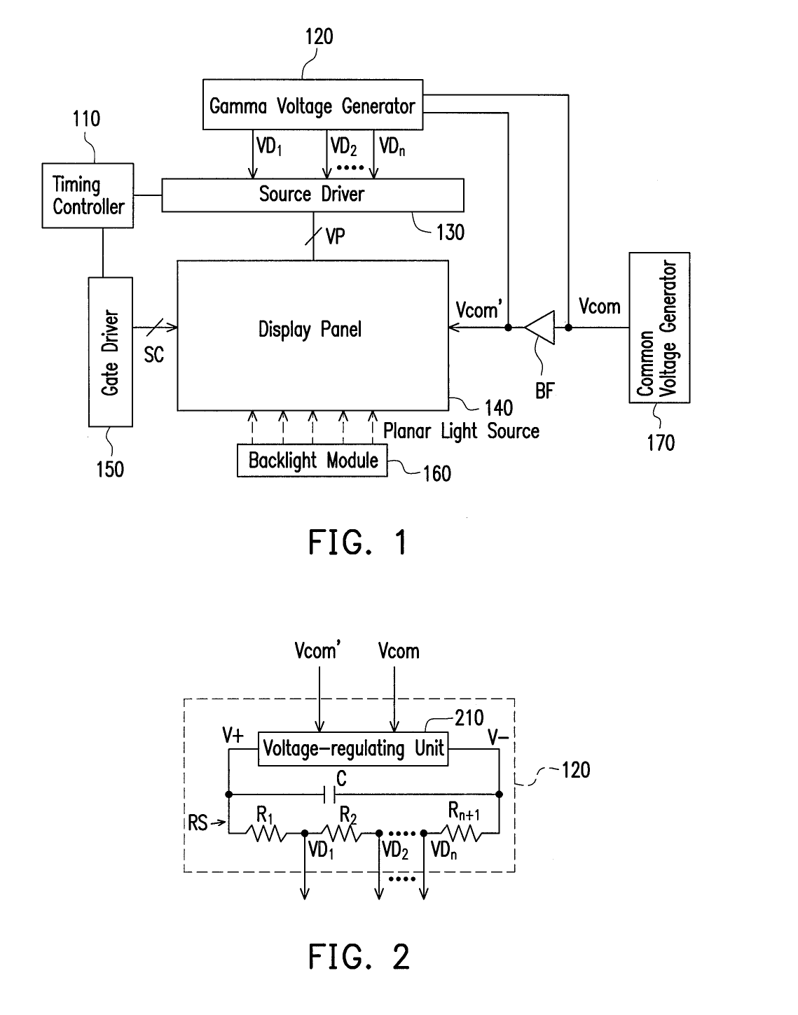

FIG. 1 is a schematic system diagram of a display apparatus according to an embodiment of the invention. Referring to FIG. 1, in the embodiment, a display apparatus 100 includes a timing controller 110, a gamma voltage generator 120, a source driver 130, a display panel 140, a gate driver 150 and a backlight module 160. The display panel 140 herein is, for example, an LCD panel. The gamma voltage generator 120 is coupled to the display panel 140 for generating a plurality of gamma voltages VD₁-VDₙ. The gamma voltage generator 120 senses a voltage coupling amount ΔVC of a common voltage Vcom′ in the display panel 140 and shifts the gamma voltages VD₁-VDₙ according to the voltage coupling amount ΔVC. The voltage coupling amount ΔVC is sensed, for example, through the voltage variation amount of the common voltage Vcom′ of the display panel 140, and the voltage coupling amount ΔVC can be generated after the common voltage Vcom′ is affected by other voltages (for example, pixel voltages VP) or signals (for example, scan signals SC) in the display panel. Herein, n is a positive integer and two times of the gray level value range of the display apparatus 100; i.e., if the gray level values of the display apparatus 100 are 0-63, n is 128.

The source driver 130 is coupled to the gamma voltage generator 120 to receive the gamma voltages VD₁-VDₙ and coupled to the timing controller 110 and the display panel 140. The gate driver 150 is coupled to the timing controller 110 and the display panel 140. The timing controller 110 is for controlling the source driver 130 to output a plurality of pixel voltages VP to the display panel 140, in which each of the pixel voltages VP is corresponding to one of the gamma voltages VD₁-VDₙ. In other words, the source driver 130 is controlled by the timing controller 110 to select one of the gamma voltages VD₁-VDₙ as a pixel voltage VP and outputs the pixel voltage VP to the display panel 140.

The timing controller 110 further controls the gate driver 150 to sequentially output a plurality of scan signals SC to the display panel 140. The backlight module 160 provides a planar light source required by the display panel 140. The display panel 140 receives the pixel voltages VP according to the scan signals SC and displays corresponding images according to the received pixel voltages VP and the planar light source provided by the backlight module 160. In the embodiment, the display panel 140 is composed of, for example, non-self-luminescent devices, while in other embodiments, the display panel 140 can be composed of self-luminescent devices and the backlight module 160 can be saved. Since the gamma voltages VD₁-VDₙ are shifted according to the voltage coupling amount ΔVC, so that when the common voltage Vcom′ is changed due to the voltage coupling amount ΔVC, the voltage differences between the pixel voltages VP and the common voltage Vcom′ keep unchanged, which can eliminate the influence of coupling the display panel 140 to the pixel voltages VP on the common voltage Vcom′.

In an embodiment of the present invention, the display apparatus 100 further includes a common voltage generator 170 and a buffer BF. The common voltage generator 170 is for generating the common voltage Vcom. The buffer BF receives the common voltage Vcom generated by the common voltage generator 170 to output the common voltage Vcom′ to the display panel 140. The common voltage Vcom′ may be varied due to couple to other voltages (for example, pixel voltages VP) or signals (for example, scan signals SC) in the display panel 140, but the common voltage Vcom is out of the influence due to the isolating of the buffer BF. As a result, the gamma voltage generator 120 can use the common voltage Vcom to detect the voltage variation amount of the common voltage Vcom′ (i.e., the voltage coupling amount ΔVC). In other embodiments, the gamma voltage generator 120 can record the initial value of the common voltage Vcom′ and uses the initial value of the common voltage Vcom′ for detecting the voltage variation amount of the common voltage Vcom′. In other words, the gamma voltage generator 120 can detect out the voltage variation amount of the common voltage Vcom′ according to the common voltage Vcom′.

FIG. 2 is a schematic circuit diagram of the gamma voltage generator of FIG. 1 according to an embodiment of the invention. Referring to FIGS. 1 and 2, in the embodiment, the gamma voltage generator 120 includes a voltage-regulating unit 210, a string of resistors RS and a capacitor C. In the embodiment, the voltage-regulating unit 210 is for generating a first reference voltage V+ and a second reference voltage V−, in which the first reference voltage V+ is greater than the second reference voltage V− by setting. The string of resistors RS is composed of, for example, a plurality of resistors R₁-Rₙ₊₁ connected in series and coupled between the first reference voltage V+ and the second reference voltage V− for performing voltage-dividing on the voltage difference between the first reference voltage V+ and the second reference voltage V− so as to generate the gamma voltages VD₁-VDₙ. The resistors R₁-Rₙ₊₁ herein are determined by the design according to the gamma curve, which the invention is not limited to. The capacitor C is coupled between the first reference voltage V+ and the second reference voltage V− for filtering out noise.

In the embodiment, the voltage-regulating unit 210 can sense the voltage coupling amount ΔVC of the display panel 140 according to the common voltages Vcom and Vcom′ and shift the first reference voltage V+ and the second reference voltage V− according to the voltage coupling amount ΔVC. When the voltage coupling amount ΔVC is positive, the voltage-regulating unit 210 would upwards shift the first reference voltage V+ and the second reference voltage V−, so that the gamma voltages VD₁-VDₙ shift upwards; when the voltage coupling amount ΔVC is negative, the voltage-regulating unit 210 would downwards shift the first reference voltage V+ and the second reference voltage V−, so that the gamma voltages VD₁-VDₙ shift downwards. The shifting amounts of the first reference voltage V+ and the second reference voltage V− can be equal to the voltage coupling amount ΔVC so that the shifting amounts of the gamma voltages VD₁-VDₙ are accordingly equal to the voltage coupling amount ΔVC.

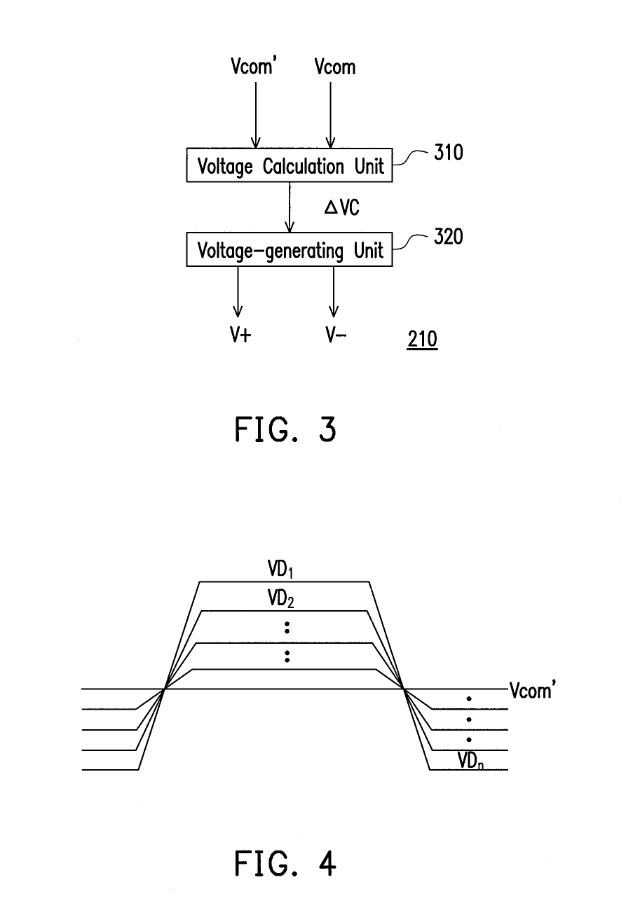

FIG. 3 is a schematic system diagram of the voltage-regulating unit of FIG. 2 according to an embodiment of the invention. Referring to FIG. 3, in the embodiment, the voltage-regulating unit 210 includes a voltage calculation unit 310 and a voltage-generating unit 320. The voltage calculation unit 310 receives two common voltages Vcom and Vcom′ for calculating the voltage coupling amount ΔVC of the common voltage Vcom′. The voltage-generating unit 320 is coupled to the voltage calculation unit 310 for generating the first reference voltage V+ and the second reference voltage V− and shifting the first reference voltage V+ and the second reference voltage V− according to the voltage coupling amount ΔVC. In some embodiments of the invention, the implementation for the voltage-generating unit 320 to shift the first reference voltage V+ and the second reference voltage V− is realized through a voltage clamp circuit, a voltage adder or other voltage-regulating techniques, which the invention is not limited to.

FIG. 4 is a schematic diagram of the gamma voltages VD₁-VDₙ and the common voltage Vcom′ in FIG. 1 according to an embodiment of the invention. Referring to FIGS. 1 and 4, in the embodiment, the common voltage Vcom′ is a DC common voltage and divides the gamma voltages VD₁-VDₙ into positive gamma voltages (for example, gamma voltages VD₁-VD_{n/2}) and negative gamma voltages (for example, gamma voltages VD_{n/2+1}-VDₙ). The common voltage Vcom′ herein is usually equal to the average value of two corresponding gamma voltages (for example, VD₁ and VDₙ or VD₂ and VDₙ₋₁) both corresponding to a same gray level value.

In summary, in the embodiments of the present invention, the gamma voltage generator and the display apparatus would detect the voltage coupling amount of the display panel so as to shift the first reference voltage and the second reference voltage according to the voltage coupling amount, which makes the gamma voltages shift correspondingly to the voltage coupling amount. In this way, the invention is able to eliminate the influence of coupling the display panel to the pixel voltages on the common voltage. In addition, the gamma voltage generator can use a capacitor to eliminate the noise between the first reference voltage and the second reference voltage.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A gamma voltage generator, comprising:
a string of resistors, coupled between a first reference voltage and a second reference voltage for generating a plurality of gamma voltages; and
a voltage-regulating unit, used for sensing a voltage coupling amount of a common voltage in a display panel and shifting the first reference voltage and the second reference voltage according to the voltage coupling amount.

2. The gamma voltage generator as claimed in claim 1, wherein the shifting amounts of the first reference voltage and the second reference voltage are equal to the voltage coupling amount.

3. The gamma voltage generator as claimed in claim 1, wherein the first reference voltage is greater than the second reference voltage.

4. The gamma voltage generator as claimed in claim 1, further comprising:
a capacitor, coupled between the first reference voltage and the second reference voltage.

5. The gamma voltage generator as claimed in claim 1, wherein the common voltage is a DC common voltage.

6. A display apparatus, comprising:
a display panel;
a gamma voltage generator, coupled to the display panel for generating a plurality of gamma voltages and shifting the gamma voltages according to a voltage coupling amount of a common voltage in the display panel;
a source driver, coupled to the gamma voltage generator to receive the gamma voltages and coupled to the display panel; and
a timing controller, coupled to the source driver for controlling the source driver to output a plurality of pixel voltages to the display panel, wherein each of the pixel voltages is corresponding to one of the gamma voltages.

7. The display apparatus as claimed in claim 6, wherein the gamma voltage generator comprises:
a string of resistors, coupled to a first reference voltage and a second reference voltage for generating a plurality of gamma voltages; and
a voltage-regulating unit, coupled to the display panel for sensing the voltage coupling amount and shifting the first reference voltage and the second reference voltage according to the voltage coupling amount.

8. The display apparatus as claimed in claim 6, wherein the shifting amounts of the first reference voltage and the second reference voltage are equal to the voltage coupling amount.

9. The display apparatus as claimed in claim 6, wherein the first reference voltage is greater than the second reference voltage.

10. The display apparatus as claimed in claim 6, wherein the gamma voltage generator further comprises a capacitor coupled between the first reference voltage and the second reference voltage.

11. The display apparatus as claimed in claim 6, wherein the common voltage is a DC common voltage.

12. The display apparatus as claimed in claim 6, wherein the display panel is a liquid crystal display panel.

13. The display apparatus as claimed in claim 6, further comprising a gate driver, coupled to the display panel and the timing controller and controlled by the timing controller to sequentially output a plurality of scan signals to the display panel.

14. The display apparatus as claimed in claim 6, further comprising a backlight module for providing a planar light source required by the display panel.
